(19) United States
(12) Patent Application Publication
(10) Pub. No.: US 2014/0092969 A1
(43) Pub. Date: Apr. 3, 2014

(54) Method and Apparatus for Data Reduction of Intermediate Data Buffer in Video Coding System

(71) Applicant: MEDIATEK INC., Hsinchu (TW)

(72) Inventors: Kun-Bin Lee, Taipei (TW); Ting-An Lin, Hsinchu (TW)

(73) Assignee: MEDIATEK INC., Hsinchu (TW)

(21) Appl. No.: 13/632,224

(22) Filed: Oct. 1, 2012

(51) Int. Cl. H04N 7/26

(52) U.S. Cl. 375/240.15; 375/240.16; 375/E07.108

(57) ABSTRACT

A method and apparatus of data reduction of search range buffer for motion estimation or motion compensation are disclosed. The method and apparatus use local memory to store reference data associated with search region to reduce system bandwidth requirement and use data reduction to reduce required local memory. The data reduction technique is also applied to intermediate data in a video coding system to reduce storage requirement associated with intermediate data. The data reduction technique is further applied to reference frames to reduce storage requirement for coding system incorporating picture enhancement processing to the reconstructed video.

### FIELD OF THE INVENTION

The present invention relates to video encoding system. In particular, the present invention relates to method and system for video coding with buffer for motion estimation.

### BACKGROUND

Motion estimation is an effective inter-frame coding technique to exploit temporal redundancy in video sequences. Motion-compensated inter-frame coding has been widely used in various international video coding standards, such as MPEG-1/2/4, H.264 and the new HEVC (High Efficiency Video Coding) standard being developed. The motion estimation adopted in various coding standards is often a block-based technique, where motion information such as coding mode and motion vector is determined for each macroblock or similar block configuration. The motion information is determined using one or more reference frames, where the reference frame may be a frame before or after the current frame in the display order. The reference frame used for motion estimation is always a previously frame so that the decoder can perform motion compensation accordingly with small amount of side information. The motion vector is usually determined by searching a surrounding area, termed as search area or search window, of a corresponding macroblock in the reference frame. In order to accommodate a potentially larger motion vector, a larger search area is required. Most video coding systems are configured for closed-loop operations where a reconstructed frame is used as a reference frame for motion estimation so that the same reference is available at the decoder side. Nevertheless, a video coding system may also use a source frame for motion estimation in order to reduce processing delay and/or to increase processing speed using multiple processors for concurrent processing. Accordingly, in this disclosure, a reference frame may also be a source frame or a reconstructed frame of a source frame.

The conventional Full-Search Block-Matching (FSBM) algorithm searches each possible location exhaustively within the search area to determine the best match. There are various fast search methods to reduce the required computations involved with the motion vector determination. Though FSBM-based approach incurs high computational cost, it is one of the favored approaches in hardware-based implementation due to its more regular data access and superior performance. Since the inter-frame video coding relies on reconstructed reference frame or frames to perform motion estimation process, the reconstructed reference frames have to be stored in the system. There have been various developments in frame buffer compression to reduce memory size for reference frame and consequently reduce system cost. Fame buffer compression for reference frame may be lossless or lossy. While lossy frame buffer compression often achieves higher compression ratio, it may introduce further degradation in the reconstructed video. Frame buffer compression also provides the benefit of reduced system bandwidth requirement. For FSBM-based approach, the system bandwidth becomes of a concern due to repeated access to data in the search area to perform the FSBM algorithm. Frame buffer compression can help to relieve the large frame buffer requirement as well as the high system bandwidth requirement.

Various frame buffer compression techniques have been disclosed in the literature. For example, a video encoder system employing reference frame buffer compression is disclosed by Demircin et al., (“TE2: Compressed Reference Frame Buffers (CRFB) ”, Document: JCTVC-B089, Joint Collaborative Team on Video Coding (JCT-VC) of ITU-T SG16 WP3 and ISO/IEC JTC1/SC29/WG11, 2nd Meeting: Geneva, CH, 21-28 July, 2010). FIG. 1A illustrates a typical adaptive inter/intra video coding system. For inter-prediction, motion estimation (ME) and motion compensation (MC) 112 is used to provide prediction data based on video data from other picture or pictures. Switch 114 selects intra-prediction or inter-prediction data and the selected prediction data are supplied to adder 116 to form prediction errors, also called residues. The prediction error is then processed by transformation (T) 118 followed by quantization (Q) 120. The transformed and quantized residues are then coded by entropy coding 122 to form a bitstream corresponding to the compressed video data. The bitstream associated with the transform coefficients is then packed with side information such as motion, mode, and other information associated with the image area. The side information may also be subject to entropy coding to reduce required bandwidth. Accordingly the data associated with the side information are provided to entropy coding 122 as shown in FIG. 1A. When an inter-prediction mode is used, a reference picture or reference pictures have to be reconstructed at the encoder end. Consequently, the transformed and quantized residues are processed by inverse quantization (IQ) 124 and inverse transformation (IT) 126 to recover the residues. The residues are then added back to prediction data 136 at reconstruction (REC) 128 to reconstruct video data. The reconstructed video data may be stored in reference picture buffer 134 and used for prediction of other frames.

As shown in FIG. 1A, incoming video data undergoes a series of processing in the encoding system. The reconstructed video data from REC 128 may be subject to various impairments due to the series of processing. Accordingly, in-loop filter 130 is applied to the reconstructed video data before the reconstructed video data are stored in the reference picture buffer 134 in order to improve video quality. The in-loop filter information may have to be transmitted in the bitstream so that a decoder can properly recover the required information. Therefore, in-loop filter information from is provided to entropy coding 122 for incorporation into the bitstream. FIG. 1B illustrates a typical adaptive inter/intra video coding system with reference frame buffer compression. In order to reduce system memory as well system bandwidth requirements, frame buffer compression (C) 152 is used before the reconstructed video data is stored in reference frame buffer 134. When the reference data from reference frame buffer 134 is required for motion estimation/motion compensation, the reference data is processed by frame buffer decompression (UC) 154 to recover the reconstructed video data.

The system block diagrams shown in FIGS. 1A-B illustrate one exemplary system partition into various modules. Other system configurations may be used to implement the video encoder. In a typical hardware-based video compression system, the processing modules shown in FIG. 1B may be implemented on a single chip except for the reference frame buffers. Without compression, the requirement of reference frame buffer may mount to several mega-bytes for an HDTV system. Therefore, external memory such as dynamic random access memory (DRAM) is often used for the reference frame buffer and the memory may be shared by other functions of the system. Another example of frame buffer compression is disclosed by Dzung Hoang to compress reconstructed reference frame with Internal Bit Depth Increase (IBDI) from 12 bits to 8 bits (“Unified scaling with adaptive offset for reference frame compression with IBDI”, Document: JCTVC-D035, Joint Collaborative Team on Video Coding (JCT-VC) of ITU-T SG16 WP3 and ISO/IEC JTC1/SC29/WG11, 4th Meeting: Daegu, Korea, 20-28 January, 2011).

The search area for a current macroblock may involve a large amount of data. In a typical video encoder, the reference data associated with the search area is read from the external reference frame memory for evaluating the best match. When the motion estimation proceeds to the next macroblock, reference data associated with the next search area have to be read from the external reference frame memory. The two neighboring search areas often are substantially overlapped. Therefore, most of the reference data will be repeatedly read from the reference frame buffer. While frame buffer compression can help to reduce the bandwidth, the repeated reference data access still represents a major waste of bandwidth and system power associated with the repeated memory access. Furthermore, each time the compressed reference data is read, decompression has to be performed and consumes system power. A data reuse technique has been disclosed by Tuan et al., where a local memory is used to buffer the reference data so as to reduce required reference data access (“On the Data Reuse and Memory Bandwidth Analysis for Full-Search Block-Matching VLSI Architecture”, IEEE TRANSACTIONS ON CIRCUITS AND SYSTEMS FOR VIDEO TECHNOLOGY, pp. 61-72, Vol. 12, NO. 1, January 2002) . Four reuse levels are defined by Tuan et al. depending on the reference data cached. Among the four reuse levels, Level C and Level D data reuse achieves high degree of reuse. FIG. 2 illustrates an example of Level C data reuse, where the solid-line box 210 indicates the search area associated with the current macroblock CB0 and the dashed-line box 220 indicates the search area associated with the next macroblock CB1. The size of the search area is (SR_{H}+N−1)×(SR_{V}+N−1), where N is the macroblock size, SR_{H} is the horizontal search range and SR_{V} is the vertical search range. As shown in FIG. 2, the reference data in the overlapped areas 230 can be reused for motion search associated with the next macroblock CB1. Consequently, only N×(SR_{V}+N−1) new reference data needs to be read for processing next macroblock CB1. The reference data associated with the search area is read into a local memory which can be embedded static RAM (SRAM) or DRAM. Off-chip SRAM/DRAM tightly coupled to the motion estimation processing may also be used, where the tightly coupled SRAM/DRAM may provide reference data for motion estimation processing without consuming much of the system bandwidth.

In order to further increase data reuse efficiency, reference data for processing a row of macroblocks may be buffered in local memory as disclosed by Tuan et al. The associated data reuse is termed as Level D data reuse by Tuan et al. FIG. 3 illustrates an example of Level D data reuse, where solid-line box 310 indicates the search areas associated with the row of macroblocks including a current macroblock CB0. Dashed-line box 320 indicates the search areas associated with the row of macroblocks including macroblock CB1. As shown in FIG. 3, the reference data in the overlapped areas 330 can be reused for motion search associated with the row of macroblocks including macroblock CB1. The size of Level D local memory is (W+SR_{H}+N−1)×(SR_{V}+N−1), where W is the picture width. The width of the Level D local memory is wider than the picture width in this example. The reference data outside the picture may be generated by data padding, extrapolation or other means. For any macroblock in the same row as the current macroblock, there is no need to read reference data from the external reference buffer since the Level D data reuse buffers all required reference data in the local memory already. While data extension outside the picture area is shown explicitly in FIG. 3, data extension may be performed implicitly based on the reference data within the picture area and therefore the Level D data reuse memory may have the same width as the picture. In other words, the Level D data reuse may also use memory with a size of W×(SR_{V}+N−1). In the conventional Level C, Level C+ and Level D data reuse methods, the data is usually stored in local memory or on-chip memory uncompressed. The reference pictures are usually stored in frame buffers based on external memory. The reference pictures may be stored in a compressed or uncompressed format. When reference data is read from frame buffers for data reuse, the reference data has to be decompressed before it is stored in local buffer if reference pictures are compressed. The search area or a set of search areas buffered in local memory is termed as search region in this disclosure. For example, Level C, C+ and D data reuses are examples of the search region.

Level D data reuse is very efficient in data usage. However, Level D data reuse requires large memory to buffer the temporary data required by motion estimation. There is an improved Level C data reuse disclosed by Chen et al., where reference data associated with multiple neighboring search areas are buffered (“Level C+ Data Reuse Scheme for Motion Estimation With Corresponding Coding Orders”, IEEE TRANSACTIONS ON CIRCUITS AND SYSTEMS FOR VIDEO TECHNOLOGY, pp. 553-558, Vol. 16, No. 4, April 2006). An example of the improved Level C data reuse (termed Level C+ by Chen et al.) is shown in FIG. 4, where the reference data for n vertically over-lapped n search areas are loaded for n vertically stitched vertical macroblocks. The vertically stitched macroblocks are termed as a vertically stitched vertical motion processing strip in this disclosure. The search areas associated with the vertically stitched vertical motion processing strip is termed as an extended search area in this disclosure. The example in FIG. 4 uses n=2 and the reference data required for Level C+ is (SR_{H}+N−1)×(SR_{V}+2 N−1). For the current stitched strip (i.e., macroblocks CB0 and CB1), the reference data corresponding to the extended search area indicated by the solid box 410 is loaded into a local memory. The reference data in box 410 is adequate for the extended search area associated with CB0 and CB1. Therefore, when motion estimation is performed for macroblock CB1, there is no need to read in any new reference data. After macroblocks CB0 and CB1 are processed, motion estimation is applied to macroblock CB2 and then macroblock CB3. The required reference data corresponding to the next extended area is indicated by dashed box 420. The reference data in shared area 430 is overlapped with box 410. Consequently, only N×(SR_{V}+2 N−1) new reference data needs to be read from external reference frame buffer. Accordingly, the efficiency of data reuse is improved over the Level C method.

As illustrated in FIGS. 2-4, the data reuse technique can substantially reduce bandwidth requirement. However, it will increase chip cost for integrated encoder since an additional local memory will be required. The local memory may be quite large for wide pictures. Therefore, it is desirable to develop system and method that can reduce the local memory requirement for motion estimation with data reuse. In addition, while the Level C and Level C+ data reuse provides a tradeoff between data reuse efficiency and local memory cost, reference data has to be loaded into local memory for each stitched blocks and frequent data access lowers memory access efficiency. Therefore, it is desirable to improve reference data access efficiency associated with Level C and Level C+ data reuse.

Furthermore, a video coding system often utilizes in-loop processing or post-processing, such as deblocking, Adaptive Offset (SAO) filter, Adaptive Loop Filter (ALF) or other in-loop filtering to enhance reconstructed picture quality. The in-loop processing or post-processing of one block may dependent on neighboring blocks. When frame buffer compression is used in such video coding system, a row of blocks may have to be temporarily buffered until a subsequent row of blocks are reconstructed. Therefore, it is desirable to apply data reduction techniques to reduce the buffer requirement.

In a video encoder or video codec, some intermediate data may be generated during the encoding process. The intermediate data will not be part of the final video bitstream. However, the intermediate data may have to be temporarily buffered for processing subsequent pictures. Therefore, it is desirable to apply forward data reduction to the intermediate data to reduce storage requirement.

### BRIEF SUMMARY OF THE INVENTION

A method and apparatus of data reduction of search range buffer for motion estimation or motion compensation is disclosed. The method utilizes forward data reduction to reduce data storage required for search range data. According to one embodiment of the present invention, the method comprises receiving reference data associated with a search region corresponding to a reference frame from a frame buffer, storing the reference data associated with the search region in local memory, wherein at least one portion of the reference data associated with the search region is in a compressed format, retrieving the reference data associated with the search area from the local memory, applying backward data reduction to the reference data associated with the search area if the reference data associated with the search area is in a compressed format, and providing the reference data associated with the search area for evaluating motion matrix of the current motion processing unit.

In another embodiment of the present invention, an apparatus for video processing incorporating motion estimation is disclosed. The apparatus comprises an interface circuit to receive reference data associated with a reference frame, a forward data-reduction module to process said at least one previous frame into compressed reference frame, a frame buffer to store the compressed reference frame, a data-reuse search buffer to store reference data of the reference frame associated with a search region required for computing motion matrix for a current motion processing unit, wherein at least one portion of the reference data associated with the search region in stored in a compressed format, and a backward data-recovery module to recover the reference data from the reference frame.

In yet another embodiment of the present invention, a method and apparatus for frame buffer compression are disclosed. The method of frame buffer compression comprises receiving reconstructed video data for one or more blocks, applying forward data reduction to one portion of said one or more blocks, wherein said one portion of said one or more blocks are fully processed by enhancement processing, storing said one portion of said one or more blocks compressed by the forward data reduction in reference frame buffer, and storing other portion of said one or more blocks yet to be fully processed by the enhancement processing in a temporary buffer, wherein said other portion of said one or more blocks requires subsequent reconstructed video data in order to be fully processed by the enhancement processing.

### BRIEF DESCRIPTION OF THE DRAWINGS

FIG. 1A illustrates a typical adaptive inter/intra video coding system.

FIG. 1B illustrates an exemplary video encoder incorporating frame buffer compression technique to reduce memory and bandwidth required associated with reference frame buffer.

FIG. 2 illustrates an example of Level C data reuse where reference data associated with a search area is stored in a local memory.

FIG. 3 illustrates an example of Level D data reuse where reference data associated with search areas across the picture width is stored in a local memory.

FIG. 4 illustrates an example of Level C+ data reuse where reference data associated with multiple search areas for multiple vertically stitched macroblocks is stored in a local memory.

FIGS. 5A-C illustrate an example of Level C data reuse at three consecutive time instances.

FIGS. 6A-D illustrate an example of modified Level C data reuse at four consecutive time instances, where multiple strips of new reference data can be read.

FIGS. 7A-C illustrate an example of Level D data reuse at three consecutive time instances.

FIG. 8A illustrates an example of search area data reuse according to an embodiment of the present invention, where the reference data in the reference frame buffer is in an uncompressed format.

FIG. 8B illustrates an example of search area data reuse according to an embodiment of the present invention, where the reference data in the reference frame buffer is in a compressed format.

FIG. 8C illustrates an example of search area data reuse according to an embodiment of the present invention, where two separate search region buffers are used.

FIG. 9 illustrates an example where a row of macroblocks are divided into two parts and each part is compressed separately.

FIG. 10A illustrates an exemplary block diagram for a video encoder or codec chip.

FIG. 10B illustrates an exemplary video encoder module.

FIG. 11A illustrates an exemplary block diagram for a video encoder or codec chip incorporating an embodiment according to the present invention.

FIG. 11B illustrates an exemplary video encoder module incorporating forward data reduction and backward data recovery.

FIG. 11C illustrates an exemplary video codec module incorporating forward data reduction and backward data recovery.

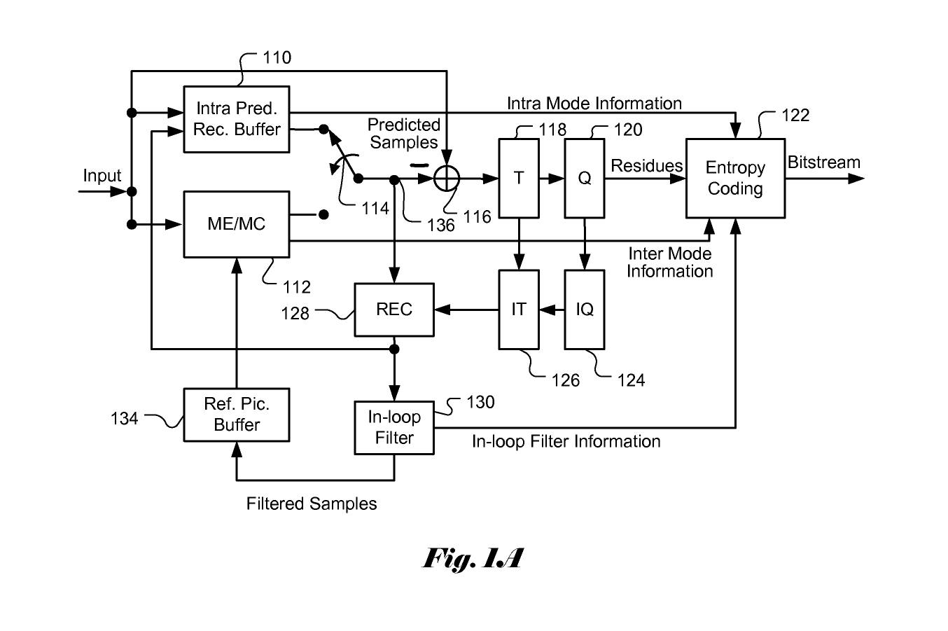

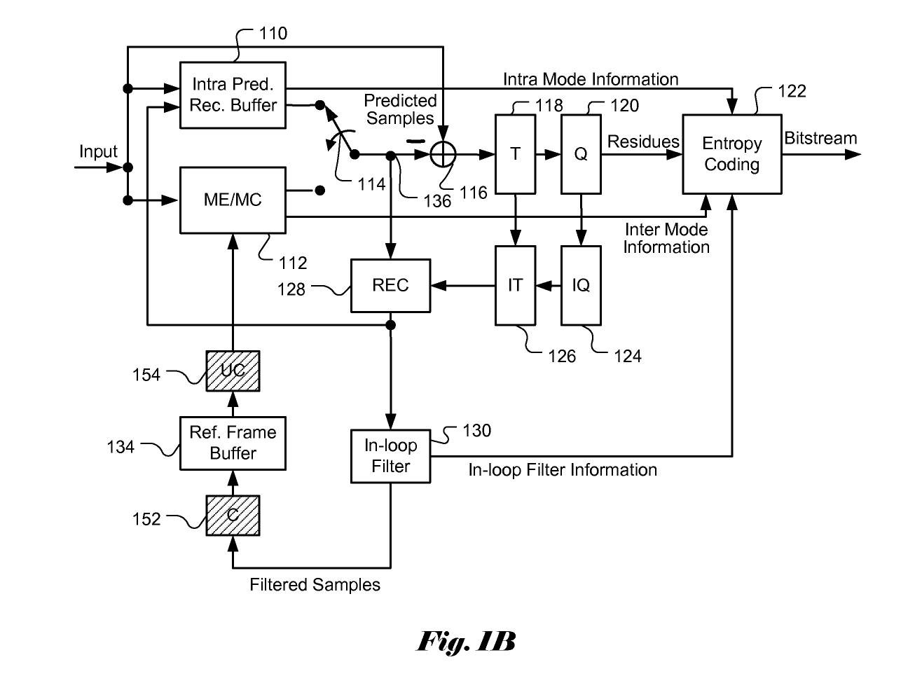

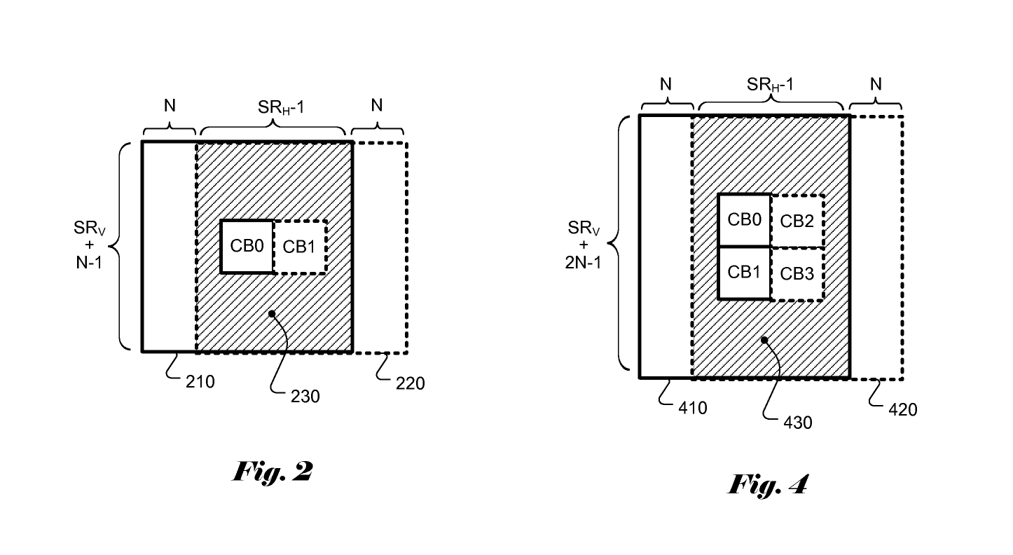

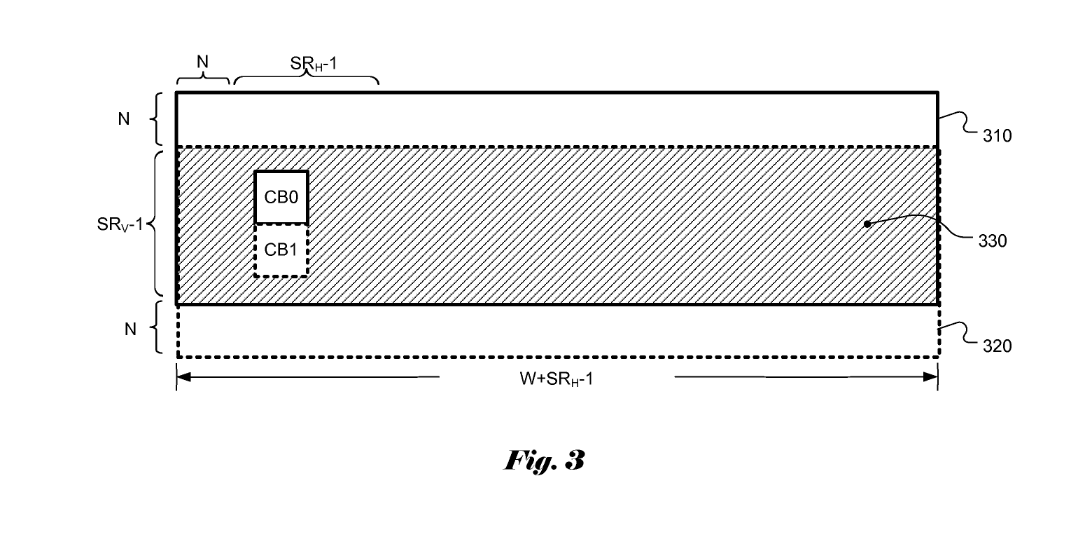

### DETAILED DESCRIPTION OF THE INVENTION

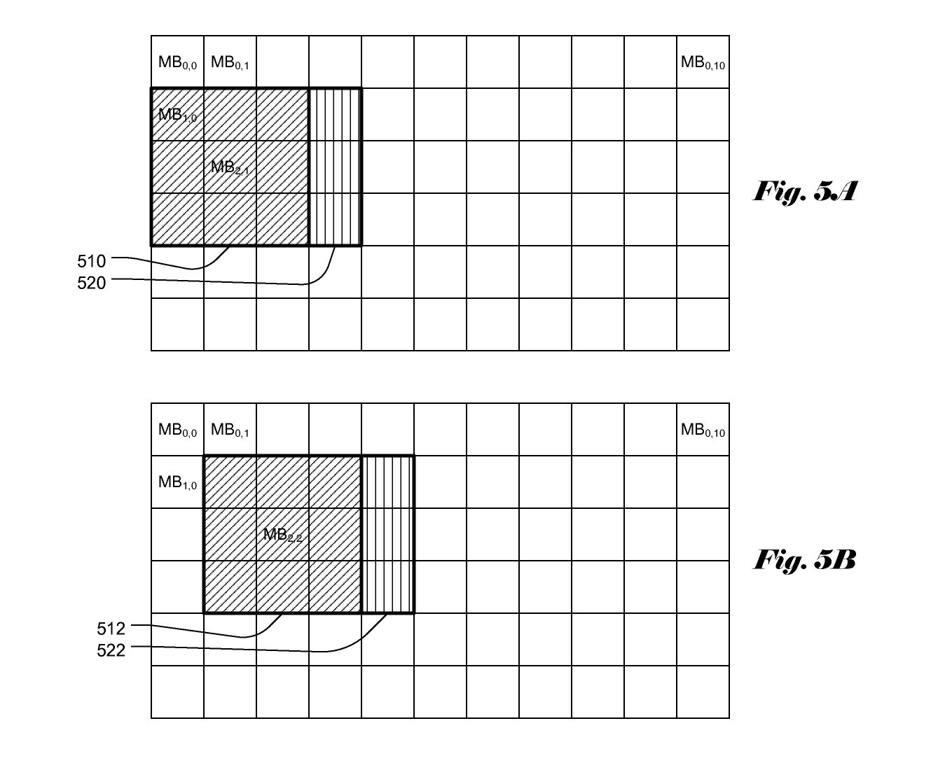

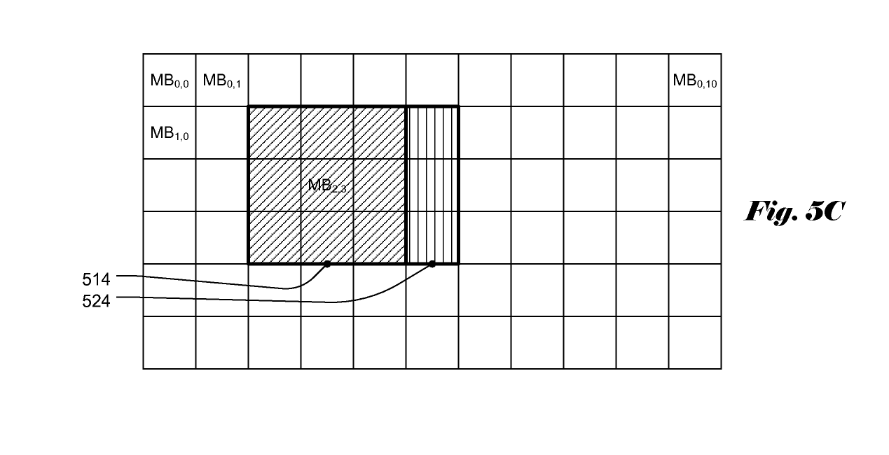

FIGS. 5A-C illustrate an example of convention Level C data reuse at three consecutive time instances, where the search are consists of 3×3 macroblocks. It is understood that the search area may be rectangular or other shapes and the search area does not have to be aligned with macroblock boundaries. Furthermore, while a macroblock has been used as a data unit for motion processing, other motion processing units may also be used. Therefore, it is understood that the “macroblock” mentioned in this disclosure is meant to illustrate an example of motion processing unit. FIG. 5A illustrates reference data associated with search area 510 is loaded into a local memory for current macroblock MB_{2,1}. The new reference data in box 520 is loaded in order to perform motion estimation for the next macroblock. Motion estimation matches a current macroblock with a spatially shifted macroblock in the search area according to a measurement, named motion matrix in this disclosure. Very often, sum of absolution differences (SAD) is used as the motion matrix. Nevertheless, other motion matrix, such as mean squared error (MSE) may also be used. The motion matrix is then provided to a decision process to determine a motion vector according to a performance criterion, such as rate-distortion optimization (RDO). FIG. 5B illustrates reference data associated with search area 512 is used for the next macroblock MB_{2,2} at the second time instance. The new reference data in box 522 is loaded in order to perform motion estimation for the further next macroblock. FIG. 5C illustrates reference data associated with search area 514 is used for the further next macroblock MB_{2,3} at the third time instance. The new reference data in box 524 is loaded in order to perform motion estimation for a subsequent macroblock. The reference data associated with the search area is always stored in a local memory in an uncompressed format. Therefore, the reference data can be readily available for motion estimation process. If the reference data stored in the reference frame buffer is in a compressed format, the reference data is decompressed before it is stored in the local memory. When the search range is large, the reference data associated with the search area will be large as well.

While Level D data reuse uses a buffer to store the search areas for a row of macroblocks, a search region according to the present invention may include search areas for multiple neighboring motion processing units. For example, a Level D data reuse buffer for HDTV may be very large and will increase system cost if the Level D buffer is implemented as on-chip memory. Consequently, a search region for a fractional row of blocks may be used, which will require only a fractional size of the Level D data reuse buffer. Accordingly, the search areas associated with multiple horizontal neighboring blocks is termed as a horizontal extended search area in this disclosure. Therefore, Level D data reuse is just an example of horizontal extended search area where the multiple horizontal neighboring blocks consists of a whole row of

An embodiment according to the present invention uses forward data reduction to reduce the required local memory size for the reference data associated with search region. The term search region used in this disclosure can be a search area as used by Level C data reuse, a vertically extended search area as used by Level C+ data reuse, or search areas corresponding to a row of macroblocks across picture width as used by Level D data reuse. The forward data reduction according to the present invention may be lossy or lossless compression, scaling or other processing procedure to reduce the required storage. An example of dynamic data range scaling is used by Chujoh et al. of Toshiba for lossy frame compression. Toshiba's Dynamic Range Adaptive Scaling by Chujoh et al. (“TE2: Adaptive scaling for bit depth compression on IBDI”, Document: JCTVC-B044, Joint Collaborative Team on Video Coding (JCT-VC) of ITU-T SG16 WP3 and ISO/IEC JTC1/SC29/WG11, 2nd Meeting: Geneva, CH, 21-28 July, 2010) uses dynamic data range scaling to reduce the required DRAM memory size for reference frame. An inverse process is performed when the compressed data in the frame buffer is read. The forward data reduction and corresponding backward data recovery can refer to more general data reduction, which includes lossy and lossless compression, data range scaling, image scaling by down-sampling and other similar techniques. Accordingly, the backward data recovery in this disclosure may be a decompression procedure to recover lossy or lossless compressed data, inverse scaling or other inverse processing procedure to recover the processed data.

During motion estimation process, a good match often found at the location of the corresponding macroblock in the reference frame (i.e., zero motion vector) or near the corresponding macroblock (i.e., small motion vector). The search process may stop after a good match is found. Therefore, the reference data corresponding to zero-motion vector or small-motion vectors may be accessed more frequent than the reference data corresponding to large-motion vectors. Consequently, it may be beneficial to keep the reference data corresponding to zero-motion vector and small-motion vectors in an un-compressed form and only apply forward data reduction to the reference data corresponding to large-motion vectors. Accordingly, in another embodiment of the present invention, reference data corresponding to search region is stored in local memory in a compressed format except for the reference data associated with zero-motion vector or small-motion vectors. The reference data associated with zero-motion vector or small-motion vectors correspond to the co-located processing unit and its surrounding processing units with small displacements. In another embodiment of the present invention, hierarchical memory organization is applied. In this embodiment, multi-level data reuse buffers are used where the data stored is in a compressed or uncompressed format. For example, a system may have a Level-D data reuse buffer in compressed format and have a Level-C or Level C+ data reuse buffer in an uncompressed format. In another example, a system may have a Level-C data reuse buffer in compressed format and have a Level-A or Level B data reuse buffer in an uncompressed format.

When lossy compression is used for forward data reduction, the associated coding parameters, such as compression ratio, may be determined based on the picture type and/or coding order of the previously reconstructed frame and/or current picture. For example, when forward data reduction is applied to a reference picture having an I-picture type, the search region associated with the reference picture should be lightly compressed to preserve high quality so as to avoid severe error propagation into subsequent pictures. On the other hand, if the reference is a P-picture near the end of a group of pictures, the search region associated with the reference picture may afford deeper compression. For another example, if current frame is a reference frame which will be referenced in the following encoding, the reference picture should be lightly compressed to preserve high quality. On the other hand, if current frame is a non-reference frame which will not be referenced in the following encoding, the reference picture may afford deeper compression.

An embodiment according to the present invention may use the same data access order as shown in FIGS. 5A-C. However, the reference data stored in the memory is read from frame buffer (such as DRAM) and processed by the forward data reduction to reduce the required local memory size for the reference data associated with search region according to the present invention. When the search region data in the local memory is needed for motion estimation, the search region data stored in a data-reduced form will be processed by the backward data recovery. The data access sequences shown in FIGS. 5A-C indicate that a vertical strip of macroblocks (three macroblocks in this example) is read every time after motion estimation is performed for a current macroblock. The single-MB vertical strip of macroblocks is used to reduce the local storage size for cost consideration. However, data access efficiency can be improved if larger amount of data is access each time since the reference frame is often stored in off-chip DRAM and there is always certainly overhead required before actual read/write data transfer starts.

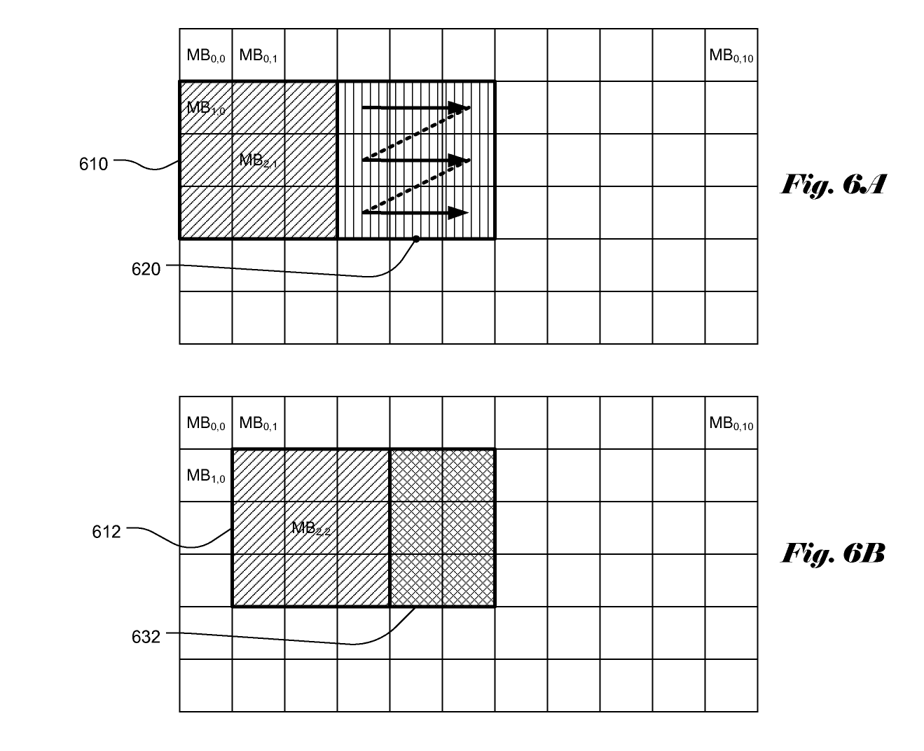

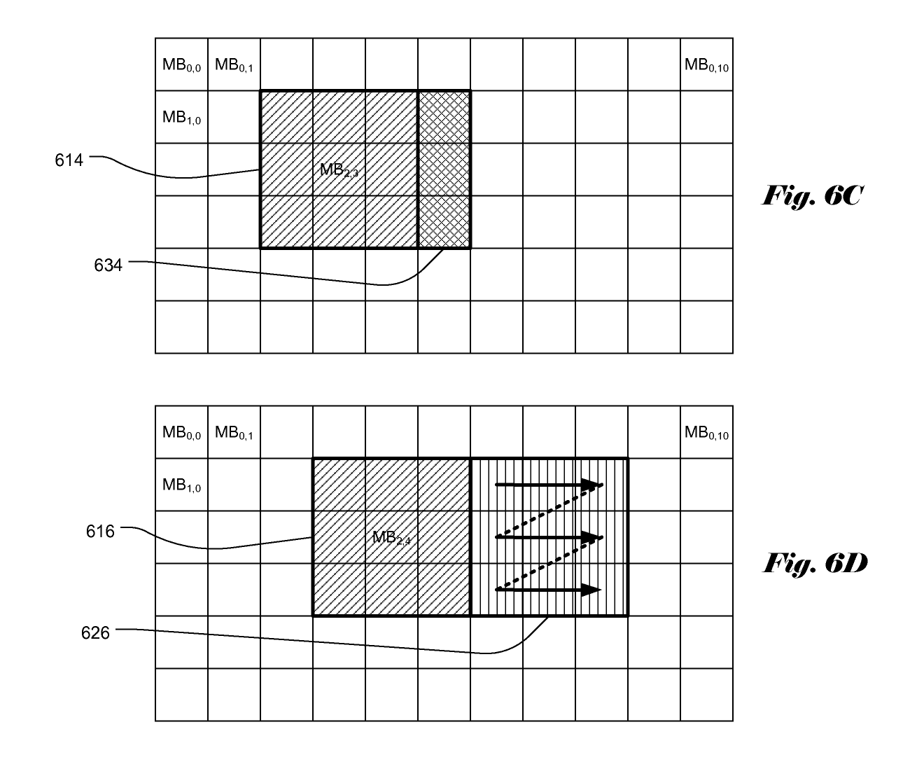

An embodiment according to the present invention may read multiple vertical strips to improve DRAM data access efficiency after motion estimation is completed for a current macroblock as shown in FIGS. 6A-D. FIG. 6A illustrates an example that the search area 610 is used for macroblock MB_{2,1} and three vertical strips of macroblocks 620 are read into the local memory after motion estimation for the current macroblock is completed. Comparing with the case in FIG. 5A where only one stripe of macroblocks is read, additional two stripes of macroblocks are pre-loaded for processing of subsequent macroblocks in the example of FIG. 6A. FIG. 6B illustrates the scenario at the second time instance where the search area 612 is used for motion estimation associated with macroblock MB_{2,2}. However, for the next two macroblocks MB_{2,3} and MB_{2,4}, the additional reference data for the corresponding search areas as indicated by shaded box 632 has been read previously and there is no need to read the additional reference data from reference frame buffer. FIG. 6C illustrates the scenario at the third time instance where the search area 614 is used for motion estimation associated with macroblock MB_{2,3}. However, for the next MB_{2,4}, the new reference data for the corresponding search area as indicated by shaded box 634 has been read previously and there is no need to read reference data from reference frame buffer. FIG. 6D illustrates the scenario at the fourth time instance where the search area 616 is used for motion estimation associated with macroblock MB_{2,4}. Three new vertical strips of macroblocks 626 are read from reference frame stored in DRAM into the local memory after motion estimation for macroblock MB_{2,4} is completed and motion estimation can be performed on the next three macroblocks before further reference data is needed. The reference frame stored in the DRAM may be in a compressed form or an un-compressed form. If the reference frame stored in the DRAM is in a compressed form, the reference data read from the DRAM has to be decompressed first.

FIG. 6A illustrates an example that the preloaded reference data is read row by row from top to bottom. Nevertheless, the preloaded reference data may also be read column by column from left to right While FIGS. 6A-D illustrate an example of pre-loading additional reference data for processing two additional subsequent macroblocks, it is understood that the present invention is not limited to pre-load for processing two additional subsequent macroblocks. Accordingly, the present invention is applicable to pre-load for processing one or more additional subsequent macroblocks. In additional, the pre-loading for processing one or more additional subsequent macroblocks may also be applied to Level C+ data re-use or other data reuse scheme that has higher data reuse performance than the Level-B scheme. For example, instead of loading N×(SR_{V}+2 N−1) reference data, additional reference data m×N×(SR_{V}+2 N−1) may be preloaded, where m is the number of additional subsequent macroblocks to be processing after the pre-load. While FIG. 6A through FIG. 6D illustrate an example of reference data preloading for Level C data re-use, the technique can also be applied to Level C+ data re-use. In the case of Level C+ data re-use, extended search areas will be required to support search for multiple vertical stitched macroblocks and multiple horizontal blocks for each preload. The reference data associated with the extended search areas will be stored in a local memory. It is desirable not to substantially increase the size of the search in order to control the cost of the corresponding encoder, decoder or codec chips while taking advantage of Level C+ data re-use and/or data preload. Accordingly, the numbers of vertical stitched macroblocks and the number of horizontal macroblocks to be preloaded have to be small. It is preferred to keep the number of vertical stitched macroblocks less than ⅛ of the picture height and the number of horizontal macroblocks to be preloaded less than ⅛ of picture width. The search range for a data re-use system having the number of vertical stitched macroblocks less than ⅛ of the picture height and the number of horizontal macroblocks to be preloaded less than ⅛ of picture width is termed a short search range in this disclosure.

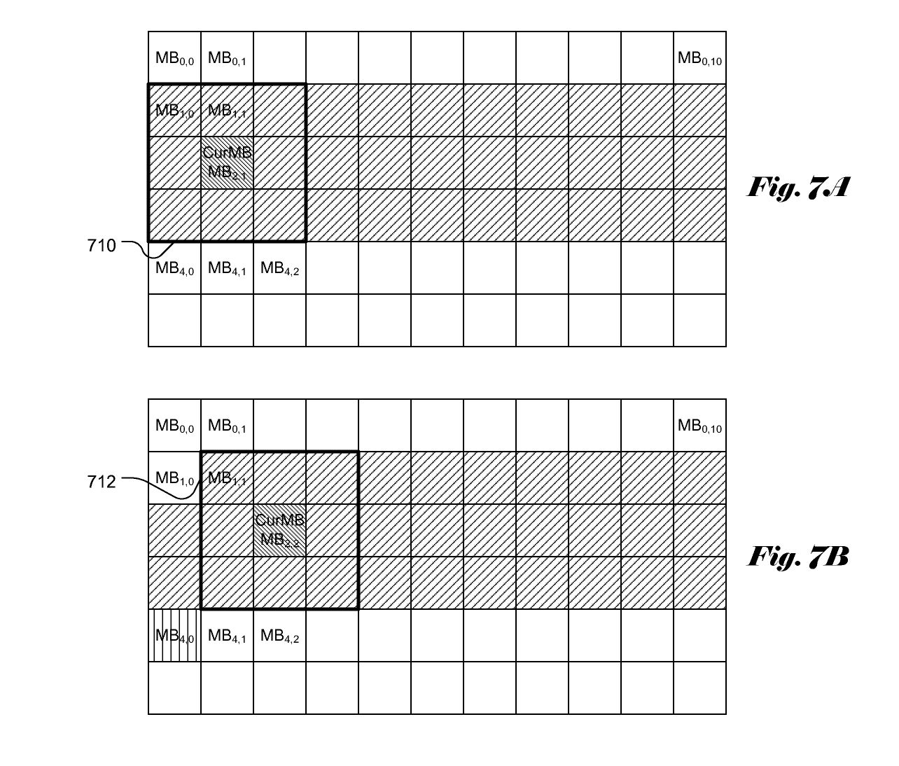

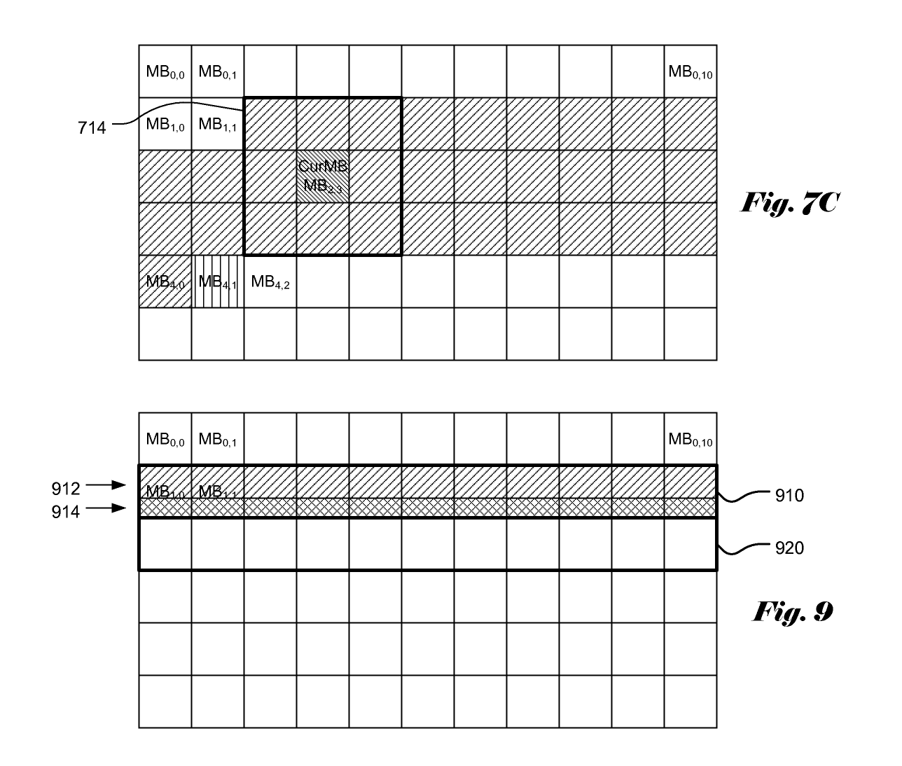

FIGS. 7A-C illustrate an example of convention Level D data reuse at three consecutive time instances, where the search area consists of 3×3 macroblocks. It is understood that the search area may be rectangular or other shapes and the search area does not have to be aligned with macroblock boundaries. The shaded area indicates the reference data stored in the local memory based on Level D data reuse. FIG. 7A illustrates reference data associated with search area 710 for current macroblock MB_{2,1}. FIG. 7B illustrates reference data associated with search area 712 for the next macroblock MB_{2,2} at the second time instance. Since the reference data for macroblock MB_{1,0} is not needed anymore and the space in the local memory can be used for new reference data. Accordingly, the new reference data corresponding to macroblock MB_{4,0} can be loaded into the local memory. FIG. 7C illustrates reference data associated with search area 714 for the further next macroblock MB_{2,3} at the third time instance. Since the reference data for macroblock MB_{1,1} is not needed anymore and the space in the local memory can be used for new reference data. Accordingly, the new reference data corresponding to macroblock MB_{4,1} can be loaded into the local memory. The example in FIGS. 7A-C illustrates an implementation of data access where reference data corresponding to a new macroblock is read into the local memory when the reference data corresponding to an old macroblock is not needed anymore. Nevertheless, a system may also load new reference data corresponding to a row of new macroblocks after motion estimation is performed for an underlying row of macroblocks.

An embodiment according to the present invention may use the same data access order as shown in FIGS. 7A-C. However, the reference data stored in the local memory is processed by the forward data reduction to reduce the required local memory size for the reference data associated with the search region. When the reference data in the local memory is needed for motion estimation, the reference data stored in a data-reduced form will be processed by backward data recovery. During the motion estimation process, the reference data associated with the corresponding search area may have to be accessed multiple times from the local memory. Every time the reference data is read, backward data recovery, such as decompression, has to apply to the data since the data is stored in a data-reduced format. The backward data recovery involves a series of operations and consumes power. It is beneficial to use an additional local memory to buffer decompressed reference data for a search area so that there is no need of repeated backward data-recovery. Consequently, another embodiment according to the present invention also uses the local memory to store uncompressed reference data for a search area while the system uses the local memory to store Level D reference data in a compressed form. Alternatively, a separate local memory may be used to buffer the uncompressed reference data for a search area. Beside the reference data for a current search area, other reference data that has to be repeatedly accessed may also be stored in the local memory in an uncompressed form. For example, a portion of the local memory can be set aside to accommodate a single macroblock data or some temporary data in an uncompressed form. In another embodiment of the present invention, hierarchical memory organization is applied. Multi-level data reuse buffers can be used with and without compressed format. For example, a system may have a Level-D data reuse buffer in compressed format and have a Level-C or Level C+ data reuse buffer in un-compressed format. For another example, a system may have a Level-C data reuse buffer in compressed format and have a Level-A or Level B data reuse buffer in un-compressed format.

FIG. 8A illustrates an example of search area data reuse according to an embodiment of the present invention. The coding system includes reference frame buffer 810 to store one or more reference frames, where the reference frames are stored in an uncompressed format. Search data-reuse buffer 820 is used to store reference data associated with a search region in order to increase data reuse efficiency. Accordingly, system bandwidth is reduced. The search data-reuse buffer usually is implemented as a local memory so that the reference data associated with a search area can be efficiently accessed. Furthermore, the local memory may be further implemented as on-chip memory. In order to reduce the cost associated with the search data-reuse buffer, Forward Data Reduction (FDR) 830 is applied to the reference data before the reference data is stored in Search data-reuse buffer 820. When the reference data stored in Search data-reuse buffer 820 is required, Backward Data Reduction (BDR) 840 is used to recover the reference data associated with a search area. The recovered reference data is then processed by motion estimation or motion compensation, where working registers may be used to buffer the recovered reference data. For a video encoder or decode chip, FDR 830 and BDR 840 may be integrated on-chip. Furthermore, Search data-reuse buffer 820 can also be integrated on-chip.

While FIG. 8A illustrates an example where the reference data stored in reference frame buffer is in an uncompressed format, a video system may store a reference frame in a compressed format in the reference frame buffer. FIG. 8B illustrates another embodiment according to the present invention, where Forward Data Reduction (FDRO) 850 is applied to the reference data associated with a reference frame before the reference data is stored in Reference frame buffer 810. When the compressed reference data stored in Reference frame buffer 810 is required, Backward Data Reduction (BDRO) 860 is used to recover the reference data associated with a reference frame. The usage of FDR 830 and BDR 840 associated with Search data-reuse buffer 820 is the same as the example of FIG. 8A. Nevertheless, the compressed format for Reference frame buffer 810 and Search data-reuse buffer 820 may be the same. In this case, the reference data retrieved from Reference frame buffer 810 may be stored in Search data reuse buffer 820 without the need of re-compression. Accordingly, circuit 870, (i.e., BDRO 860 and FDR 830) may be eliminated in this case. When FDRO 850 and BDRO 860 are used, they can be integrated on-chip for a video encoder or decode chip.

FIG. 8C illustrates yet another embodiment according to the present invention, where two search data-reuse buffers are used, where first Search data-reuse buffer 820a is used to store search region corresponding to more macroblocks in a compressed format while second Search data-reuse buffer 820b is used to store search region corresponding to a current macroblock or a few immediate macroblocks to be processed in an uncompressed format. The use of second Search data-reuse buffer 820b can reduce the need of repeated backward data reduction. Since second Search data-reuse buffer 820b is intended to buffer smaller amount of reference data compared with first Search data-reuse buffer 820a, it will not noticeably increase system cost. For example, first Search data-reuse buffer 820a may be a Level-D data reuse buffer while second Search data-reuse buffer 820b may be Level-C or Level C+ data reuse buffer. For another example, first Search data-reuse buffer 820a may be a Level-C data reuse buffer while second Search data-reuse buffer 820b may be a Level-A or Level-B data reuse buffer.

The forward data reduction and the corresponding backward data recovery mentioned above are used to reduce data size associated with reference data for motion estimation. The said forward data reduction and the corresponding backward data recovery may also be used to reduce data size of reference frame buffer. In a video encoder, decoder or codec using inter-frame coding, the reconstructed video data may have to be stored in reference frame buffer for motion estimation and/or motion compensation and the reconstructed video data will be used as predictor for subsequent frame or frames. In a straightforward approach, whenever a reconstructed macroblock is ready, the forward data reduction can be applied to the reconstructed macroblock and the data-reduced macroblock is written into the reference frame buffer. However, in some newer video coding systems, the reconstructed video data may undergo picture enhancement processing, such as de-blocking, Adaptive Offset (SAO) filter or Adaptive Loop Filter (ALF), to improve quality of the reconstructed video. The picture enhancement processing for a currently reconstructed macroblock may rely on data from neighboring macroblocks. If the previously reconstructed neighboring macroblocks are in a compressed format, decompression has to be applied to convert the previously reconstructed neighboring macroblocks into an uncompressed form. Therefore, it may be beneficial to temporarily store the previously reconstructed neighboring macroblocks in an uncompressed form. After picture enhancement processing is performed on a currently reconstructed macroblock, the associated previously reconstructed neighboring macroblocks may not be needed for picture enhancement processing of other reconstructed macroblocks. The forward data reduction can now apply to the previously reconstructed neighboring macroblocks. For example, the de-blocking process used in newer video standards applies de-blocking filter to pixels around boundaries based on the current block and its immediate neighboring blocks. A row of currently reconstructed and de-blocked macroblocks can be temporarily buffered. After deblocking is performed on the next row of reconstructed macroblock, the forward data reduction can be applied to the currently reconstructed and de-blocked row of macroblocks. The corresponding reduced data can now be stored in the local memory. When lossy compression is used for forward data reduction, the associated coding parameters, such as compression ratio, may be determined based on the picture type and/or coding order of current frame. For example, if the current frame is a reference frame which will be referenced in the following encoding, the current frame should be lightly compressed to preserve high quality. On the other hand, if current frame is a non-reference frame which will not be referenced in the subsequent coding, the reference frame may afford deeper compression.

For picture enhancement processing where the processing is applied across macroblocks, the processing may be applied to pixels around the block boundaries. The processing of the next row of macroblocks may depend on a few lines at the bottom of the row of currently reconstructed and enhancement processed macroblocks. FIG. 9 illustrates an example of picture enhancement processing across macroblocks. A row of currently reconstructed and enhancement processed macroblocks is indicated by box 810 and the next row of macroblocks is indicated by box 820. Picture enhancement processing of the next row of macroblocks depends on a few lines 914 at the bottom of the row of currently reconstructed and enhancement processed macroblocks. Lines 912 in the upper part of the row of currently reconstructed and enhancement processed macroblocks are not involved in the picture enhancement processing of the next row of macroblocks. When frame buffer compression is used in a system without the enhancement processing mentioned above, the reconstructed macroblocks can be compressed one by one as soon a block is reconstructed. Alternatively, multiple blocks, may be temporarily stored in an output queue to improve memory access efficiency. However, when frame buffer compression is applied to a system where enhancement of a reconstructed block relies on surrounding constructed blocks, a currently reconstructed block may not be fully deblocked until the below block in the following macroblock row is available as shown in FIG. 9. Therefore, after picture enhancement processing of a reconstructed macroblock, forward data reduction can be applied to lines 912 of the reconstructed macroblock. However, enhancement processing of lines 914 of the reconstructed macroblock in a current row requires the corresponding reconstructed macroblock in the next row. Therefore, lines 914 for the reconstructed macroblock in the current row have to be temporarily buffered in a compressed or uncompressed form. After picture enhancement processing of lines 914 of the reconstructed macroblock is completed, lines 914 of the reconstructed macroblock can be compressed and stored in a frame buffer. An embodiment according to the present invention separately applies forward data reduction to lines 912 and lines 914 of one or more macroblocks. In other words, forward data reduction is applied to the top part and the bottom of one or more macroblocks separately.

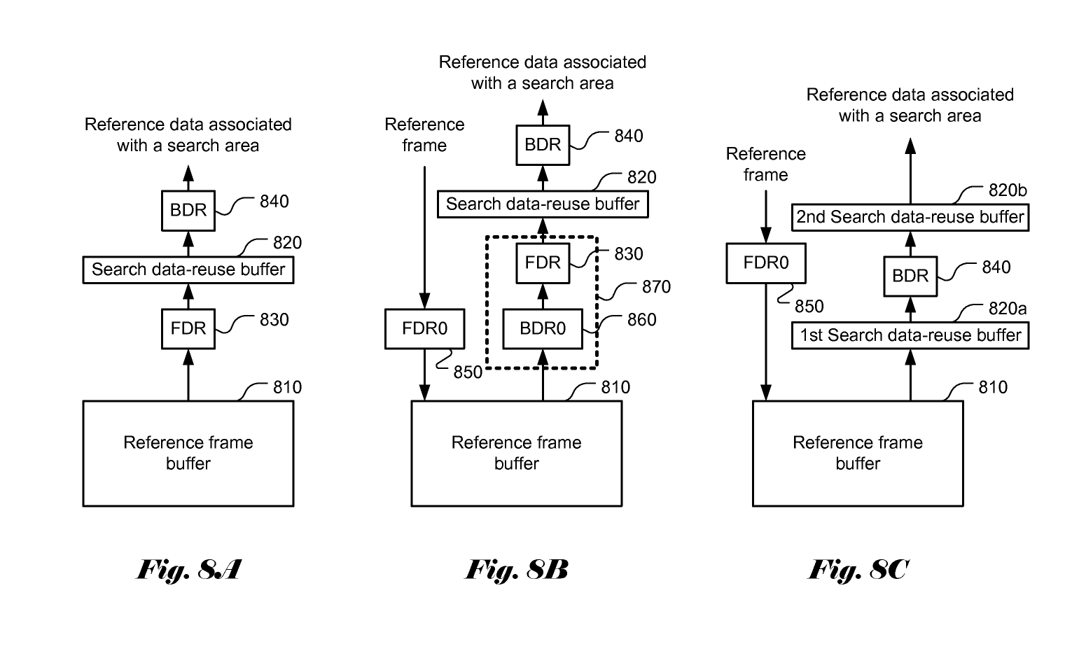

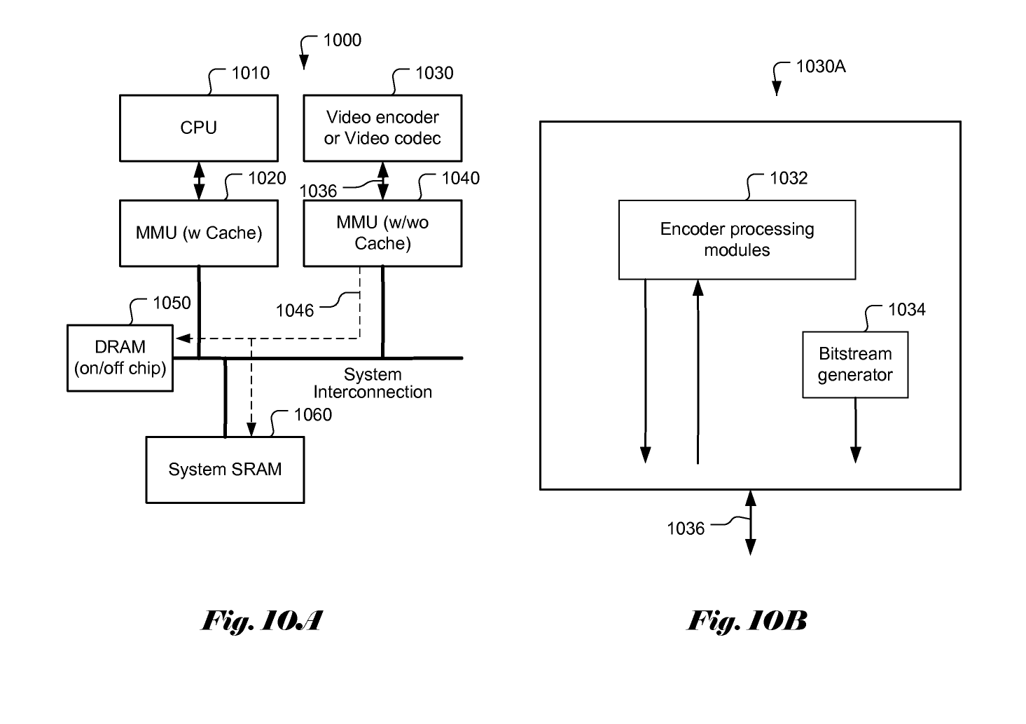

An embodiment of the present invention can be incorporated into a video encoder, video decoder or video codec to reduce data buffer requirement for intermediate data. FIG. 10A illustrates an example of system block diagram 1000 for a video encoder or codec chip, where the system comprises CPU 1010, Memory Management Unit (MMU) 1020 associated with CPU 1010, video encoder/codec 1030 and associated MMU 1040, DRAM 1050 and System RAM 960. MMU 1020 for CPU 1010 typically includes cache. On the other hand, MMU 1040 for video encoder/codec 1030 may or may not include cache. DRAM 1050 may be on-chip or off-chip. When on-chip DRAM is used, the on-chip DRAM is also called embedded DRAM. MMU 1020, MMU 1040, DRAM 1050 and system SRAM 960 are interconnected so that data can be transferred from one place to the other place under the control of MMU 1020 or MMU 1040. FIG. 10B illustrates an exemplary encoder block diagram 1030A, where the encoder comprises encoder processing modules 1032 and bitstream generator 1034. Encoder 1030A interfaces with other modules of the video encoder chip through MMU 1040 via interface 1036. For example, the compressed video bitstream generated by bitstream generator 1034 may be provided to an external memory through system interconnection under control signal 1046 from MMU 1040. Also, encoder processing modules 1032 may access video input data through system interconnection under the control signal 1046 from MMU 1040.

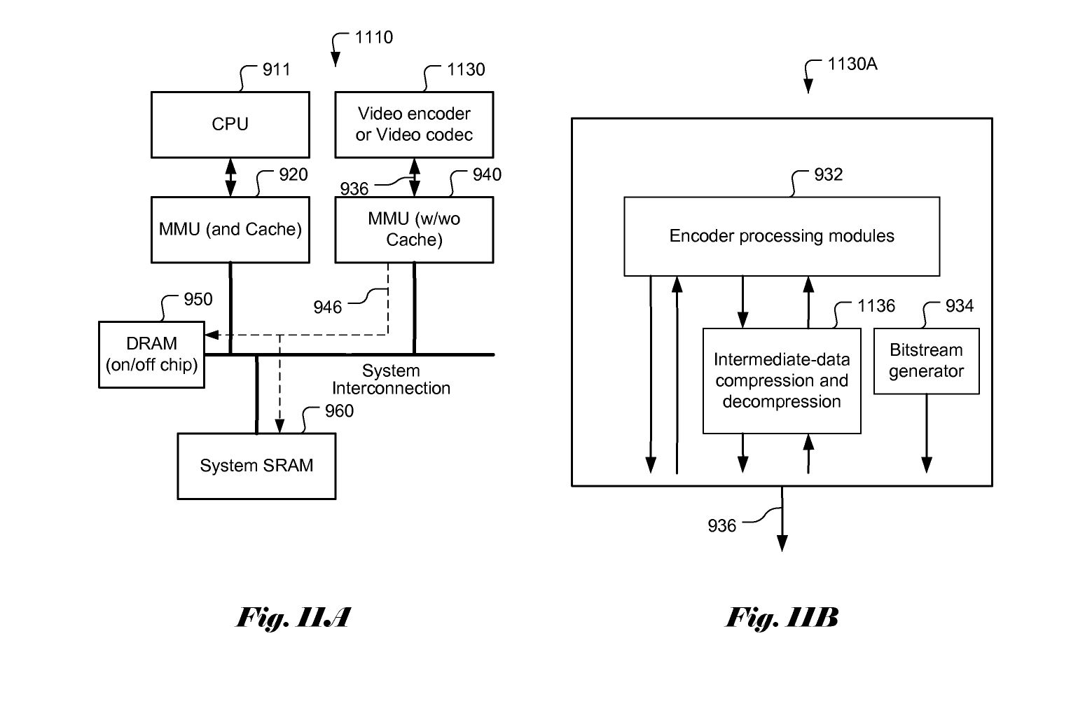

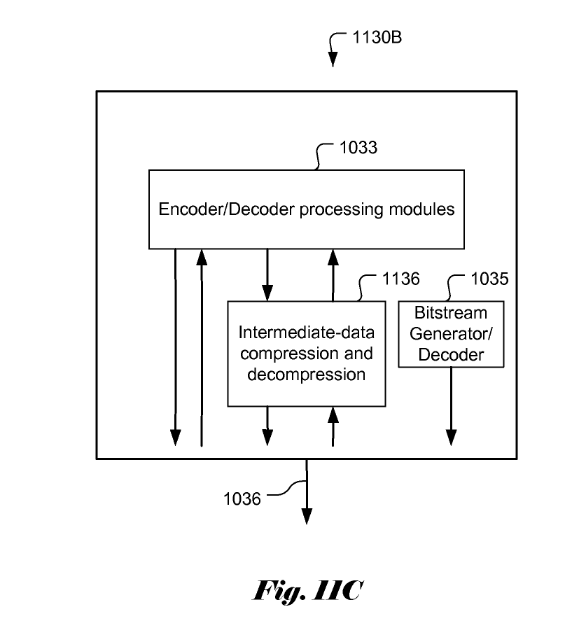

During the coding process, the system may generate some temporary data. The temporary data may stay for the period of a macroblock, a group of macroblocks, a frame or a group of frames. However, the temporary data may or may not become part of the compressed bitstream. However, during encoding process, storage has to be provided for the temporary data and the storage may be sizeable. Therefore, it is desirable to store the temporary data in a compressed form according to one embodiment of the present invention. Examples of temporary data include a reconstructed frame, motion vector, residual data, partial deblocked data, partial loop-filtered data, spatial neighboring information, and any combination of the above. FIG. 11A illustrates an example of system block diagram 1110 for a video encoder or codec chip incorporating an embodiment of the present invention. The modules in FIG. 11A are mostly the same as those in FIG. 10A except for video encoder/codec 1030. The same modules will use same reference numerals. An exemplary video encoder module 1130A incorporating an embodiment of the present invention is illustrated in FIG. 11B. Encoder module 1130A includes an additional module, intermediate-data compression and decompression 1136 to implement the forward data reduction and the backward data recovery mentioned about. While a single functional block 1136 is shown in FIG. 11B for implementing the forward data reduction and the backward data recovery, two separate functional blocks may also be used to implement the forward data reduction and the backward data recovery separately. The compressed data may be stored in DRAM 1050 and/or system RAM 960 and/or the storage inside video encoder/codec 1030. All the modules shown in FIG. 11B may be integrated into a single encoder chip. DRAM 1050 can be integrated on the same video encoder chip or can be implemented separately. Furthermore, all modules in FIG. 11A, where video encoder 1130A is used, can be integrated in a single encoder system chip except for DRAM 1050, where DRAM 1050 can be integrated on the same video encoder system chip or can be implemented separately.

An exemplary video codec module 1130B incorporating an embodiment of the present invention is illustrated in FIG. 11C. Video codec module 1130B is similar to video encoder module 1130A except that encoder processing modules 1032 is replaced by encoder/decoder processing modules 1033 and bitstream generator 1034 is replaced by bitstream generator/decoder 1035. Encoder module 1130B includes intermediate-data compression and decompression 1136 to implement the forward data reduction and the backward data recovery mentioned about. The compressed data may be stored in DRAM 1050 and/or system RAM 960. Again, all the modules shown in FIG. 11C may be integrated into a single codec chip. DRAM 1050 can be integrated on the same video encoder chip or can be implemented separately. Furthermore, all modules in FIG. 1110C, where video codec 1130B is used, can be integrated in a single codec system chip except for DRAM 1050, where DRAM 1050 can be integrated on the same video codec system chip or can be implemented separately.

Embodiment of reference data reduction according to the present invention as described above may be implemented in various hardware, software codes, or a combination of both. For example, an embodiment of the present invention can be multiple processor circuits integrated into a video compression chip or program codes integrated into video compression software to perform the processing described herein. An embodiment of the present invention may also be program codes to be executed on a computer CPU having multiple CPU cores or Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware codes may be developed in different programming languages and different format or style. The software code may also be compiled for different target platform. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method of data reduction of search range buffer for motion estimation or motion compensation, the method comprising:
receiving reference data associated with a search region corresponding to a reference frame from a frame buffer, wherein the search region corresponding to a search area for a current motion processing unit, a vertical extended search area for vertically stitched motion processing strip containing the current motion processing unit, a horizontal extended search area for at least two horizontal neighboring motion processing units containing the current motion processing unit, or any combination thereof;
storing the reference data associated with the search region in local memory, wherein at least one portion of the reference data associated with the search region is in a compressed format;
retrieving the reference data associated with the search area from the local memory;
applying backward data reduction to the reference data associated with the search area if the reference data associated with the search area is in the compressed format; and
providing the reference data associated with the search area.

2. The method of claim 1, said the reference data associated with the search area is used for evaluating motion matrix of the current motion processing unit.

3. The method of claim 1, further comprising applying forward data reduction to said at least one portion of the reference data associated with the search region if the reference data associated with the search region received from the frame buffer is not compressed.

4. The method of claim 3, wherein parameters of the forward data reduction are selected according to picture type and/or coding order of a current frame, a previously reconstructed frame, or a combination thereof

5. The method of claim 1, wherein said at least one portion of the reference data associated with the search region is in the compressed format using lossy compression, lossless compression, or image scaling.

6. The method of claim 1, wherein the reference data corresponding to a short extended search range of the reference data associated with the search area, the horizontal extended search area, or the vertical extended search area is stored in the local memory.

7. The method of claim 1, wherein the search region includes a first search area and a second search area; wherein the first search area is selected from a first group consisting of a first horizontal extended search area and a first vertical extended search area; wherein the second search area is selected from a second group consisting of the search area for the current motion processing unit, a second horizontal extended search area and a second vertical extended search area; and wherein the second search area is within boundaries of the first search area.

8. The method of claim 7, wherein the reference data associated with the first search area is stored in the local memory in the compressed format; and wherein the reference data associated with the second search area is stored in the local memory or a second local memory in an uncompressed format.

9. The method of claim 1, further comprising pre-loading the reference data associated with an additional search area, an additional horizontal extended search area, or an additional vertical extended search area for one or more subsequent motion processing units, one or more horizontal neighboring motion processing units, or one or more vertically stitched motion processing strips respectively.

10. The method of claim 9, wherein the reference data associated with the additional search area, the additional horizontal extended search area, or the additional vertical extended search area is pre-loading in a row-by-row order or a column-by-column order.

11. An apparatus for video processing incorporating motion estimation, motion compensation, or a combination thereof, the apparatus comprising:
an interface circuit to receive reference data associated with a reference frame;
a forward data-reduction module to process the reference frame into compressed reference frame, wherein the compressed reference frame is stored in a frame buffer;
a data-reuse search buffer to store reference data of the reference frame associated with a search region required for a current motion processing unit, wherein at least one portion of the reference data associated with the search region is stored in a compressed format; and
a backward data-recovery module to recover the reference data from the reference frame.

12. The apparatus of claim 11, further comprising a local buffer to store at least another portion of the reference data associated with the search region, wherein said at least another portion of the reference data is stored in an un-compressed format.

13. A method for video processing, the method comprising:
applying video encoding process to video data to generate video bitstream, wherein said video encoding process also generates intermediate data which is not incorporated into the video bitstream;
applying first forward data reduction to the intermediate data to generate reduced intermediate data; and
applying first backward data recovery to recover the intermediate data from the reduced intermediate data, wherein the intermediate data recovered is used by the video encoding process.

14. The method of claim 13, wherein the intermediate data includes a reconstructed frame, motion vector, residual data, partial deblocked data, partial loop-filtered data, spatial neighboring information, and any combination of the reconstructed frame, the motion vector, the residual data, the partial deblocked data, the partial loop-filtered data, the spatial neighboring information or any combination thereof

15. The method of claim 13, further comprising applying second forward data reduction to second intermediate data to generate second reduced intermediate data, wherein said video encoding process also generates the second intermediate data; and
applying second backward data recovery to recover the second intermediate data from the second reduced intermediate data, wherein the second intermediate data recovered is used by the video encoding process.

16. An apparatus for video encoder or video codec, the apparatus comprising:
a video processing unit to generate video bitstream from video data, wherein the video processing unit also results in intermediate data;
a forward data-reduction module operable to generate compressed intermediate data from the intermediate data; and
a backward data-recovery module operable to recover the intermediate data from the compressed intermediate data.

17. The apparatus of claim 16, further comprising:
a second forward data-reduction module operable to generate compressed second intermediate data from second intermediate data, wherein the video processing unit also results in the second intermediate data; and
a second backward data-recovery module operable to recover the second intermediate data from the compressed second intermediate data.

18. A method of frame buffer compression for an image or video processing system, the method comprising:
receiving reconstructed frame data for one or more blocks;
applying forward data reduction to one portion of said one or more blocks, wherein said one portion of said one or more blocks are fully processed by enhancement processing;
storing said one portion of said one or more blocks compressed by the forward data reduction in reference frame buffer; and
storing other portion of said one or more blocks yet to be fully processed by the enhancement processing in a temporary buffer, wherein said other portion of said one or more blocks requires subsequent reconstructed frame data in order to be fully processed by the enhancement processing.

19. The method of claim 18, wherein said other portion of said one or more blocks is stored in the temporary buffer in a compressed format or an uncompressed format.

20. An apparatus for an image or video processing system, the apparatus comprising:
an interface to receive one or more blocks corresponding to reconstructed frame data;
a forward data reduction module to compress one portion of said one or more blocks, wherein said one portion of said one or more blocks are fully processed by enhancement processing;
a reference frame buffer to store said one portion of said one or more blocks compressed by the forward data reduction, wherein; and
a temporary buffer to store other portion of said one or more blocks yet to be fully processed by the enhancement processing , wherein said other portion of said one or more blocks requires subsequent reconstructed frame data in order to be fully processed by the enhancement processing.

21. The apparatus of claim 20, further comprising a backward data reduction module operable to decompress data stored in the reference frame buffer, wherein the data decompressed by the backward data reduction module is stored in a data reuse buffer for motion estimation or motion compensation.
